(19) United States
(12) Patent Application Publication
(10) Pub. No.: US 2021/0164858 A1
(43) Pub. Date: Jun. 3, 2021

(54) SYSTEMS AND METHODS FOR LEAK TESTING A COMPONENT

(71) Applicant: Caterpillar Inc., Peoria, IL (US)

(72) Inventor: Jessica P. Armentrout, Schertz, TX (US)

(73) Assignee: Caterpillar Inc., Peoria, IL (US)

(21) Appl. No.: 16/700,716

(22) Filed: Dec. 2, 2019

(51) Int. Cl. G01M 3/02; G01M 3/26; G01K 13/02; G01M 15/04

(52) U.S. Cl. CPC G01M 3/025; G01M 3/26; G01K 2013/024; G01M 15/04; G01K 13/02

(57) ABSTRACT

A system for leak testing a component of an industrial machine. The system can include a supply, a first temperature sensor, a second temperature sensor, a temperature change unit and a controller. The supply can be configured to provide a gas to an interior of the component. The first temperature sensor can be configured to sense a temperature of the component. The second temperature sensor can be configured to sense a temperature of the gas of the supply. The controller can be configured to electronically communicate with the first temperature sensor and the second temperature sensor and can be configured to control the temperature change unit based upon the sensed temperature of the component and the sensed temperature of the gas of the supply to heat or cool the gas be substantially the same as the temperature of the component.

### TECHNICAL FIELD

The present application relates generally, but not by way of limitation, to leak testing of various components, such as but not limited to, an engine of an industrial, paving, agricultural, construction and/or earth-moving machine. More particularly, the present application relates to systems and methods for leak testing having a controller configured to control a temperature of a test medium (e.g., a gas of a gas supply to the component) during the leak testing such that the test medium has substantially a same temperature as that of a temperature of the component undergoing the leak testing.

### BACKGROUND

Machines such as industrial, paving, agricultural, military, construction and earth-moving machines typically utilize combustion engines as a power source for providing motive force to the machine as well as for generating power for operation of other systems, such as hydraulic systems, cooling systems and the like. In manufacturing the combustion engines for installation in such machines, it is common practice to leak test the combustion engines during manufacture to determine if they are constructed to adequately prevent or have minimal amounts of leakage of fluid such as lubricating oil.

Furthermore, industrial, paving, agricultural, construction and earth-moving machines may utilize various accessory components to the engine. These can be mounted to the engine. For example, fuel pumps, water pumps and compressor housings can be mounted to the engine block. In order to provide sealing between the accessory component and the engine block it may be desirable to leak test such components including prior to or after mounting to the engine.

In process testing in high volume manufacturing environments makes long temperature stabilization periods impractical. Thus, typical leak testing practice is conducted using a method in which the component temperature is monitored during the leak test and the test parameters are adjusted based on sampling of a population to determine how to best accommodate the dynamics of a test where the temperatures are not at ambient and the cycle time does not allow for thermodynamic equilibrium to be reached. Even with component temperature monitoring and evaluation of a population of components, the thermodynamic and gas dynamic effects within a component are highly variable and are not feasible to model with any useful degree of accuracy.

U.S. Pat. No. 7,104,116 to Dicenzo, entitled “Fluid Sensor Fixture For Dynamic Fluid Testing” applies to integrated dynamic and continuous (or intermittent) fluid monitoring in equipment. Dicenzo does not apply to in process testing during the manufacturing and/or assembly phase of that equipment.

### SUMMARY OF THE INVENTION

A system for leak testing a component of an industrial machine during manufacture of such component, the system can optionally include a supply, a first temperature sensor, a second temperature sensor, a temperature change unit and a controller. The supply can be configured to provide a gas to an interior of the component. The first temperature sensor can be coupled to the component and configured to sense a temperature of the component. The second temperature sensor can be coupled to the supply and can be configured to sense a temperature of the gas of the supply. The temperature change unit can be coupled to the supply and can be configured to heat or cool the gas of the supply to the component. The controller can be configured to electronically communicate with the first temperature sensor and the second temperature sensor and can be configured to control the temperature change unit based upon the sensed temperature of the component and the sensed temperature of the gas of the supply to heat or cool the gas of the supply such that the temperature of the gas to the component can be substantially the same as the temperature of the component.

A system for leak testing a component of an industrial machine during manufacture of such component, the system can optionally include a supply, a regulator, a temperature change unit, a first temperature sensor, a second temperature sensor and a controller. The supply can be configured to provide a gas to an interior of the component for the leak testing of the component. The regulator can be coupled to the supply and configured to regulate a flow of the gas to the component. The first temperature sensor can be coupled to the component and can be configured to sense a temperature of the component. The second temperature sensor can be coupled to the supply between the regulator and the component and can be positioned immediately adjacent the component. The second temperature sensor can be configured to sense a temperature of the gas of the supply. The temperature change unit can be coupled to the supply between the regulator and the component and can be configured to heat or cool the gas of the supply. The controller can be configured to electronically communicate with the first temperature sensor and the second temperature sensor and can be configured to control the temperature change unit based upon the sensed temperature of the component and the sensed temperature of the gas of the supply to heat or cool the gas of the supply such that the temperature of the gas of the supply to the component can be between ±0.3° C. of the temperature of the component.

A method for leak testing a component during manufacture, the method can optionally comprise: coupling a gas supply to the component to provide a gas to an interior of the component; sensing a temperature of the component; sensing a temperature of the gas of the gas supply prior to entering the component; heating or cooling the gas of the gas supply to the component to have the temperature thereof be substantially the same as the temperature of the component based upon the sensing of the temperature of the component and the sensing of the temperature of the gas of the gas supply; and determining if the component has a leak.

### BRIEF DESCRIPTION OF THE DRAWINGS

FIG. 1 is a schematic diagram of a first system for leak testing a component according to an example of the present application.

FIG. 2 is a schematic diagram of a second system for leak testing the component according to another example of the present application.

FIG. 3 is a flow chart of a method of leak testing according to an example of the present application.

### DETAILED DESCRIPTION

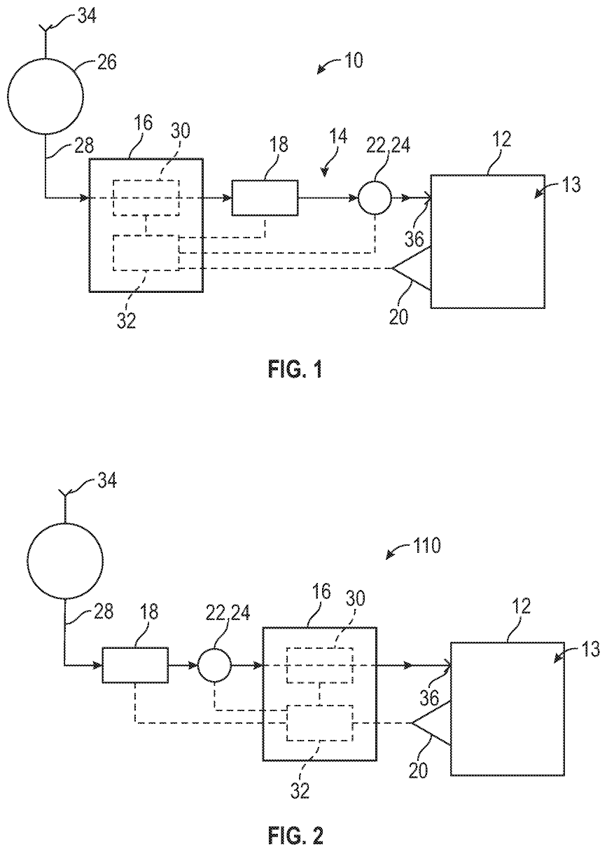

FIG. 1 is a schematic diagram of a system 10 for leak testing a component 12 during manufacture of the component 12. The system 10 can utilize a compressible fluid such as a gas (e.g., air, compressed air, nitrogen, carbon dioxide, etc.) for the leak testing, for example. The system 10 can include a supply 14, a test station 16, a temperature change unit 18, a first temperature sensor 20, a second temperature sensor 22 and a pressure sensor 24. The supply 14 can include a buffer tank 26 and one or more lines 28. The test station 16 can include a regulator 30 and a controller 32.

Although a single component is shown in FIG. 1, it should be noted that the system 10 can be configured to test a plurality of components simultaneously according to some examples. As shown in the example of FIG. 1, the component 12 can have a hollow interior 13 or cavity and can be prepared for the leak testing by closing or otherwise blocking orifices that are in fluid communication with the environment outside of the hollow interior 13 or cavity of the component 12. The component 12 can be coupled to the supply 14 so the hollow interior 13 or cavity can be in fluid communication therewith. The supply 14 can comprise a gas supply, for example, and can extend from an inlet 34 of the supply 14 to an outlet 36 at (e.g., within) the component 12. The supply 14 via the one or more lines 28 can couple to and be in fluid communication with the test station 16, the temperature change unit 18, the second temperature sensor 22 and the pressure sensor 24, for example. Although a single pathway (line 28) for the supply 14 is illustrated in FIG. 1, it should be recognized that multiple pathways such as to multiple components can be utilized according to some examples of the supply.

The test station 16 can comprise an electronic interface with various components for a user to perform the leak testing. Thus, the test station 16 can include the regulator 30 and the controller 32, for example. Additional components such as a display, user interface (e.g., touchscreen, keyboard, etc.) can be components of the test station 16 but are not specifically illustrated in FIG. 1.

The temperature change unit 18 can be coupled to the supply 14 and can be positioned downstream (in a direction flow) from the test station 16. Thus, the temperature change unit 18 can be between the test station 16, and components thereof such as the regulator 30 and the component 12. The temperature change unit 18 can be configured as a heating or cooling unit 18A to heat or cool the gas of the supply to the component 12. It is contemplated that in alternative embodiments the system 10 can include both a separate heating unit and a separate cooling unit or single unit configured for heating and cooling the gas of the supply 14.

According to one example, the temperature change unit 18 can be configured as an in-line heating unit or in-line cooling unit. In the case of the in-line heating unit, the unit can have an electric resistance-based heating element positioned in the supply 14 such that the gas of the supply 14 flows over or through the heating element and is heated thereby. In the case of the in-line cooling unit, the unit can have a cooling coil positioned in the supply 14 such that the gas of the supply 14 flows over or through the cooling coil and is cooled thereby.

The first temperature sensor 20 can be configured to be positioned on or within the component 12 so as to be in contact therewith. The first temperature sensor 20 can be configured to sense a temperature Tc of the component 12. The first temperature sensor 20 can be configured as one of a thermocouple, a resistance temperature detector (RTD), a negative temperature coefficient (NTC) thermistor or semiconductor based integrated circuit, for example.

The second temperature sensor 22 and the pressure sensor 24 can be coupled to the supply 14 and can be positioned downstream of the temperature change unit 18. Put another way, the second temperature sensor 22 and the pressure sensor 24 can be positioned between the temperature change unit 18 and the component 12. As shown in FIG. 1, the second temperature sensor 22 and/or the pressure sensor 24 can be positioned immediately adjacent the component 12 (e.g., within a few feet thereof). The second temperature sensor 22 can be configured to measure a temperature Tᵢₙ of the gas of the supply 14. The pressure sensor 24 can be to sense a pressure Pᵢₙ of the gas of the supply. The pressure sensor 24 can be part of a sensor unit with the second temperature sensor 22 (e.g., can be positioned with the second temperature sensor 22) or can be positioned immediately adjacent the second temperature sensor 22 (within a few feet thereof), for example.

The buffer tank 26 can be utilized in some examples of the supply 14. The buffer tank 26 can comprise a pressurized reservoir for the gas utilized by the system 10 such as in instances where the component 12 has a large internal volume or a plurality of components are being leak tested. Thus, the buffer tank 26 can be an optional component of the system 10. The inlet 34 can be located downstream of the buffer tank 26. The inlet 34 can communicate with ambient air (e.g., manufacturing plant air) or can communicate with another source of gas/compressible fluid, for example.

The one or more lines 28 can extend from the inlet 34 to the outlet 36. The one or more lines 28 can be configured to allow for fluid communication of the gas/compressible fluid therethrough along a pathway from the inlet 34 to the outlet 36. The one or more lines 28 can comprise pipe and/or hose, for example, that can be clamped, threaded, passed through, or otherwise coupled to the various components illustrated in FIG. 1. As discussed previously, although a single pathway for the one or more lines 28 is illustrated in FIG. 1, it is contemplated that a plurality of lines comprising a plurality of pathways can be utilized according to some examples.

According to the example of FIG. 1, the regulator 30 can be part of the test station 16. According to other examples, the regulator 30 can be a separate component. The regulator 30 can comprise a valve configured to regulate the flow of the gas through the supply 14 to achieve a desired pressure within the supply 14 and/or within the component 12.

The controller 32 can be configured to electronically communicate with various components of the system 10 including, but not limited to, having input signals from the first temperature sensor 20, the second temperature sensor 22 and/or the pressure sensor 24. The controller 32 can also be configured to electronically communicate with, have output signals to the regulator 30 and/or the temperature change unit 18. Such electronic communication is illustrated by dashed lines in FIG. 1. The controller 32 can comprise one or more embedded or integrated controllers, one or more processors, microprocessors, microcontrollers, electronic control modules (ECMs), electronic control units (ECUs), or any other suitable means for electronically determining and/or controlling the system 10.

The controller 32 can be configured to operate according to a predetermined algorithm or set of instructions for determining and controlling various components of the system 10 based on various operating conditions including, for example, input from the first pressure sensor 20, the second pressure sensor 22 and/or the pressure sensor 24.

It is further contemplated that the controller 32 can be configured to continuously perform various calculations such as comparing the sensed temperature of the component with the sensed temperature of the gas of the supply and control (e.g., output a signal or otherwise communicate) with the temperature change unit 18 to heat or cool the gas to the component such that the temperature of the gas of the supply to the component is principally the same as the temperature of the component within a desired tolerance for temperature. As used as an example herein, the temperature of the gas of the supply is considered to be substantially or principally the same as that of the component and is within the desired tolerance for temperature if it is between ±0.3° C. of the temperature of the component. For example, the sensed temperature of the gas of the supply can be used as an input to heat or cool the gas of the supply such that the temperature of the gas of the supply to the component would be maintained within ±0.3° C. of the temperature of the component. The tolerance for temperature range of the supply gas would be dependent upon the desired accuracy and speed of the test being performed as well as the capability of the test system. Thus, broader temperature ranges (e.g., ±0.5° C., ±0.75° C., ±1.0° C., ±1.5° C., ±2.0° C., etc.) are contemplated and are considered to be substantially the same and within the desired tolerance for temperature according to some examples.

The controller 32 and other components of the system 10 can be configured to communicate with one another and with other components not specifically shown. This electronic communication can be via various wired or wireless communications technologies and components using various public and/or proprietary standards and/or protocols. Examples of transport mediums and protocols for electronic communication between components of the system 10 include Ethernet, Transmission Control Protocol/Internet Protocol (TCP/IP), 802.11 or Bluetooth, or other standard or proprietary transport mediums and communication protocols.

Algorithms or set of instructions of the controller 32 can be stored in a database and can be read into an on-board memory of the controller 32, or preprogrammed onto a storage medium or memory accessible by the controller 32, for example, in the form of a hard drive, jump drive, optical medium, random access memory (RAM), read-only memory (ROM), or any other suitable computer readable storage medium commonly used in the art (each referred to as a “database”).

Although the controller 32 is illustrated as part of the test station 16, according to other examples the controller 100 can be implemented on a remote computing device such as a server enabled mobile phone or tablet, for example.

The controller 32 can be in electronic communication so that the controller 32 can receive data pertaining to the current operating parameters (e.g., temperature of the component, temperature of the gas of the supply, pressure of the gas of the supply, etc.) of the system 10 from the various sensors. In response to such input, the controller 32 may perform various determinations and transmit output signals corresponding to the results of such determinations or corresponding to actions that need to be performed, such as heating or cooling the gas of the supply such that the temperature of the gas to the component is substantially the same as the temperature of the component.

According to one example, the controller 32 can be a proportional-integral-derivative controller. As such, the controller 32 can be configured to take the inputs provided (e.g., temperature of the component, temperature of the gas of the supply, pressure of the gas of the supply, etc.) and can be configured to selectively control the output(s), in particular, the control signal to the temperature change unit 18. Such controlling can include signal tuning, for example. The proportional-integral-derivative can be a gain or gains that the controller 32 applies to raw proportional, derivative and integral variables. For example, the proportional variable of the controller 32 can apply power to the temperature change unit 18 as the controller 32 attempts to decrease a degree of error between the temperature of the gas of the supply to the component and the temperature of the component to achieve the substantially the same temperature for each. According to one example, the degree of error can be multiplied by a proportional value so the higher the proportional value is, the faster the controller 32 and the temperature change unit 18 will respond. The derivative variable can act as a damper to reduce the rate of change of the temperature change unit 18 in providing heating or cooling. As such, the controller 32 can multiply the current rate of change by the derivative value and can then subtract this value from the calculation made with the proportional value. The integral variable can determine the output (heating or cooling) of the temperature change unit 18 as a function of the sum of all the errors as the temperature change unit 18 works to achieve the substantial equalization of the temperature of the gas of the supply with the temperature of the component. Whereas the proportional and derivative variables may only take into account a current measurement and perhaps one or two temperature and/or pressure measurements immediately preceding them, the integrated variable can use many previous temperature and/or pressure readings to reduce the error and correct the process value to reach the substantial equalization of the temperature of the gas of the supply with the temperature of the component.

The present inventor has recognized that previous solutions to leak testing can have drawbacks. For example, in process testing in high volume manufacturing environments makes long temperature stabilization periods impractical. Alternatives using component temperature monitoring and evaluation of a population of components also have drawbacks as they are prone to a degree of error and inaccurate test results. The present disclosure is directed to systems and methods for leak testing that reduces the degree of error and improves accuracy of test results as the systems and methods mitigates the complex dynamics of heat transfer and gas dynamics given there is little or no stabilization required when the test medium (here the gas of the supply to the component) is already at substantially a thermodynamic equilibrium with the component before it is introduced into the interior of the component.

FIG. 2 is a schematic diagram of another system 110 for leak testing a component 12 with the hollow interior 13 or cavity during manufacture of the component 12. The system 110 can utilize the same components as the system 10 previously illustrated in FIG. 1. Thus, the system 110 can include the component 12, the supply 14, the test station 16, the temperature change unit 18, the first temperature sensor 20, the second temperature sensor 22 and the pressure sensor 24. The supply 14 can include the buffer tank 26, the one or more lines 28, the inlet 34 and the outlet 36. The test station 16 can include the regulator 30 and the controller 32.

The system 110 can differ from the system 10 in that the temperature change unit 32, the second temperature sensor 22 and/or the pressure sensor 24 can be arranged upstream (in a direction of flow of the gas of the supply) of the regulator 30.

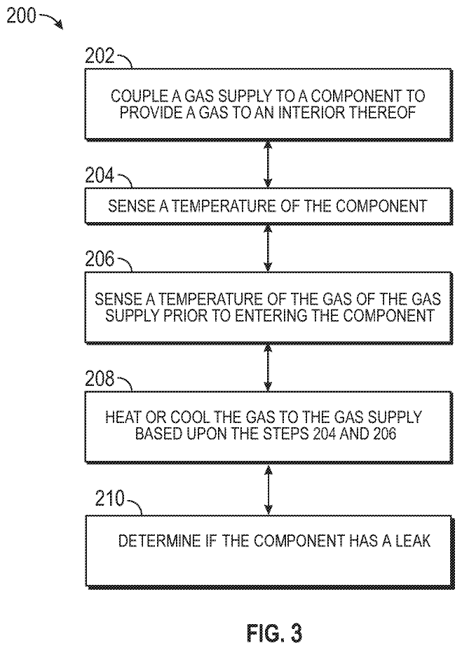

FIG. 3 is a flow diagram illustrating a method 200 for leak testing a component during manufacture. The component can be formed by any suitable manufacturing method. In examples, the component can be manufactured using a hot forming process(es) that uses a molten or softened metal such as die casting, investment casting, sand casting and forging processes where suitably malleable materials are typically used, such as aluminum and magnesium alloys, and even titanium alloys. As discussed above, the leak testing can occur in process with the manufacture.

At step 202, the method 200 can include coupling a gas supply to the component to provide a gas to an interior of the component. In particular, one or more gas lines can be inserted in or otherwise connected to the component. Other steps, such as blocking external orifices of the component to the environment can be taken prior to the coupling.

At step 204, the method 200 can include sensing a temperature of the component. This step can be conducted using a thermocouple, a resistance temperature detector (RTD), a negative temperature coefficient (NTC) thermistor or semiconductor based integrated circuit, in contact with the component.

At step 206, the method 200 can include sensing a temperature of the gas of the gas supply prior to entering the component. This can be accomplished by a temperature sensor coupled to the gas supply, for example. The sensing of step 204 and step 206 can occur substantially simultaneously, for example.

At step 208, the method 200 can include heating or cooling the gas of the gas supply to the component to have the temperature thereof be substantially the same as the temperature of the component based upon the sensing of the temperature of the component and the sensing of the temperature of the gas of the gas supply. It should be noted that at least the step 206 can occur before, during or after step 208 according to some examples. Tus, the sensing the temperature of the gas of the gas supply can occur after the heating or cooling the gas of the gas supply to the component as the second temperature sensor can be arranged downstream in the supply of the temperature change unit. Various feedback loops as discussed above can be used to provide the temperature of the gas of the gas supply as an input such that an appropriate amount of heating or cooling to the gas of the supply to achieve the substantially the same temperature of the component and the gas of the gas supply. The step 208 can be performed with a temperature change unit such as an in-line heating or cooling component, for example. This can heat or cool the gas of the gas supply to the temperature to closely match the temperature of the component. Temperature monitoring of the component and/or the temperature of the gas of the gas supply provides feedback to a controller/control system which maintains the test pressure and the temperature of the gas of the gas supply to closely match that of the temperature of the component. Thus, the temperature of the gas of the gas supply entering the component thus substantially equals the temperature of the component.

At step 210, the method can determine if the component has a leak. This determination can utilize a pressure decay test. In the pressure decay test the component is pressurized, stabilized to some degree, then the source of the test medium (e.g., compressed air) is isolated from the component while a pressure transducer continues to monitor the pressure within the unit under test (UUT) (the component and the supply to the component). The pressure decay over time is indicative of the leak rate and this independent variable can have a pass/fail criteria based on the amount of pressure decay. Alternatively or additionally, the determination can utilize an absolute mass flow test. In the absolute mass flow test, the component is pressurized, stabilized, but the test medium (e.g., compressed air) continues to supply the UUT throughout the test to maintain a constant pressure. The test equipment can have a flow meter that measures the mass flow rate of air (or other test medium) and that independent variable can be the pass/fail criteria for this type of test. According to further examples, the determination can utilize other known methods of leak testing such as a Tracer gas testing method or high pressure testing using compressed gasses such as those used for ASME BPVC tests (for example, a test under ASME B31.3 for metallic piping components requires exceeding the design operating pressure by 110%-133% until stabilization is obtained, then reducing the pressure to 100% of design pressure and then isolating the supply for the decay portion of the test).

### INDUSTRIAL APPLICABILITY

The present disclosure describes various systems, devices and methods for leak testing of components in process with the manufacture thereof. More particularly, the present disclosure relates to systems and methods for leak testing having a controller configured to control a temperature of a test medium (e.g., a gas of a gas supply to the component) during the leak testing such that the test medium has substantially as same temperature as that of a temperature of the component undergoing the leak testing.

The systems and methods for leak testing of the present disclose accommodate in process testing of components during manufacture while reducing the degree of error and improving accuracy of test results as compared with typical methods. Thus, the systems and methods better mitigate the complex dynamics of heat transfer and gas dynamics given there is little or no stabilization required when the test medium (here the gas of the supply to the component) is already at substantially a thermodynamic equilibrium with the component before it is introduced into the interior of the component. Increased accuracy of test results and shorter cycle time in station provides cost and efficiency savings as instances of false positive leak test and false negative leak test results are reduced and the test station can test more product over time with the reduction or elimination of the stabilization period.

What is claimed is:

1. A system for leak testing a component of an industrial machine, the system comprising:
a supply configured to provide a gas to an interior of the component;
a first temperature sensor coupled to the component and configured to sense a temperature of the component;
a second temperature sensor coupled to the supply and configured to sense a temperature of the gas of the supply;
a temperature change unit coupled to the supply and configured to heat or cool the gas of the supply to the component; and
a controller configured to electronically communicate with the first temperature sensor and the second temperature sensor and configured to control the temperature change unit based upon the sensed temperature of the component and the sensed temperature of the gas of the supply to heat or cool the gas of the supply such that the temperature of the gas to the component is substantially the same as the temperature of the component.

2. The system of claim 1, further comprising a regulator coupled to the supply and configured to regulate a flow of the gas to the component.

3. The system of claim 2, wherein the regulator comprises a part of a leak test station that additionally includes the controller.

4. The system of claim 2, wherein the temperature change unit and the second temperature sensor are arranged one of upstream or downstream of the regulator.

5. The system of claim 1, wherein the controller comprises a proportional-integral-derivative controller.

6. The system of claim 1, wherein the second temperature sensor is positioned at the supply downstream of the temperature change unit and is positioned immediately adjacent the component.

7. The system of claim 6, further comprising a pressure sensor configured to sense a pressure of the gas of the supply downstream of the temperature change unit, wherein the pressure sensor is positioned with or immediately adjacent the second temperature sensor.

8. The system of claim 1, wherein the temperature change unit comprises one of an in-line heater or in-line cooler positioned within the supply.

9. The system of claim 1, wherein the temperature of the gas of the supply is controlled to be between ±0.3° C. of the temperature of the component.

10. A system for leak testing a component of an industrial machine, the system comprising:
a supply configured to provide a gas to an interior of the component for the leak testing of the component;
a regulator coupled to the supply and configured to regulate a flow of the gas to the component;
a first temperature sensor coupled to the component and configured to sense a temperature of the component;
a second temperature sensor coupled to the supply between the regulator and the component and positioned immediately adjacent the component, wherein the second temperature sensor is configured to sense a temperature of the gas of the supply;
a temperature change unit coupled to the supply between the regulator and the component and configured to heat or cool the gas of the supply; and
a controller configured to electronically communicate with the first temperature sensor and the second temperature sensor and configured to control the temperature change unit to heat or cool the gas of the supply based upon the sensed temperature of the component and the sensed temperature of the gas of the supply such that the temperature of the gas of the supply to the component is between ±0.3° C. of the temperature of the component.

11. The system of claim 10, wherein the controller comprises a proportional-integral-derivative controller, and wherein the temperature change unit comprises one of an in-line heater or in-line cooler positioned within the supply.

12. The system of claim 10, further comprising a pressure sensor configured to sense a pressure of the gas of the supply downstream of the temperature change unit, wherein the pressure sensor is positioned with or immediately adjacent the second temperature sensor.

13. A method for leak testing a component during manufacture, the method comprising:
coupling a gas supply to the component to provide a gas to an interior of the component;
sensing a temperature of the component;
sensing a temperature of the gas of the gas supply prior to entering the component;
heating or cooling the gas of the gas supply to the component to have the temperature thereof be substantially the same as the temperature of the component based upon the sensing of the temperature of the component and the sensing of the temperature of the gas of the gas supply; and
determining if the component has a leak.

14. The method of claim 13, further comprising regulating a flow of the gas of the gas supply to the component.

15. The method of claim 14, wherein the sensing the temperature of the gas of the gas supply and the heating or cooling the gas of the gas supply to the component occurs between the component and the regulating the flow of the gas of the gas supply to the component.

16. The method of claim 14, wherein the sensing the temperature of the gas of the gas supply and the heating or cooling the gas of the gas supply to the component occurs downstream of the regulating the flow of the gas of the gas supply to the component.

17. The method of claim 16, further comprising sensing a pressure of the gas of the gas supply.

18. The method of claim 13, wherein the heating or cooling the gas of the gas supply occurs within the gas supply.

19. The method of claim 13, wherein the heating or cooling the gas of the gas supply to the component is controlled such that the temperature of the gas of the gas supply to the component is between ±0.3° C. of the temperature of the component.

20. The method of claim 13, wherein the sensing the temperature of the gas of the gas supply occurs after the heating or cooling the gas of the gas supply to the component.
